(19) United States
(12) Patent Application Publication
(10) Pub. No.: US 2025/0262903 A1
(43) Pub. Date: Aug. 21, 2025

(54) DAMPER TOP MOUNT

(71) Applicant: The Pullman Company, Milan, OH (US)

(72) Inventor: Joseph F. Cerri, Norwalk, OH (US)

(21) Appl. No.: 18/581,619

(22) Filed: Feb. 20, 2024

(51) Int. Cl. B60G 13/00

(52) U.S. Cl. CPC B60G 13/003; B60G 2204/128; B60G 2206/722

(57) ABSTRACT

A damper mount comprises an isolator coupled to a housing. The isolator comprises an inner core, an outer shell, and an elastomeric body positioned therebetween. The inner core includes a first plate coupled to a second plate. The first plate includes a circumferentially extending outer wall. The second plate includes a flange positioned in engagement with the outer wall. The outer shell includes a circumferentially extending wall circumscribing the inner core. The elastomeric body is bonded to the outer shell as well as the first plate and the second plate of the inner core. The circumferentially extending outer wall of the first plate and the circumferentially extending wall of the outer shell extend substantially parallel to one another with a portion of the elastomeric body positioned therebetween.

### FIELD

Top mount assemblies are used with dampers including shocks and struts within suspension systems of motor vehicles. A top mount assembly including a multi-piece inner component providing a light weight and cost-effective solution is discussed.

### BACKGROUND

The statements in this section merely provide background information related to the present disclosure and may not constitute prior art.

Known top mount assemblies typically include an outer metal cap fixed to a body of a vehicle. The mount assembly often includes a central inner component that is at least partially encapsulated with an elastomeric or plastic material. A piston rod of the damper is fixed to the inner component. The inner component and the elastomeric material are positioned within and at least partially covered by the cap. Encapsulation of the inner component may be costly and time consuming. A need exists for a lower cost solution.

### SUMMARY

A damper mount comprises an isolator coupled to a housing. The isolator comprises an inner core, an outer shell, and an elastomeric body positioned therebetween. The inner core includes a first plate coupled to a second plate. The first plate includes a circumferentially extending outer wall. The second plate includes a flange positioned in engagement with the outer wall. The outer shell includes a circumferentially extending wall circumscribing the inner core. The elastomeric body is bonded to the outer shell as well as the first plate and the second plate of the inner core. The circumferentially extending outer wall of the first plate and the circumferentially extending wall of the outer shell extend substantially parallel to one another with a portion of the elastomeric body positioned therebetween.

In another arrangement, a damper mount includes an isolator coupled to a housing. The isolator comprises an inner core including a first plate coupled to a second plate. The first plate includes a circumferentially extending outer wall. The second plate includes a flange including an annular outer surface. The annular outer surface is positioned in engagement with an inner surface of the outer wall. The damper mount includes an outer shell having a circumferentially extending wall circumscribing the inner core. An elastomeric body is bonded to the circumferentially extending wall of the outer shell and the first plate. The elastomeric body includes a central portion positioned between the circumferentially extending outer wall and the outer shell. The central portion is loaded in shear in response to a load attempting to move the inner core relative to the outer shell in an axial direction.

### BRIEF DESCRIPTION OF DRAWINGS

The drawings described herein are for illustration purposes only and are not intended to limit the scope of the present disclosure in any way.

FIG. 1 is an illustration of an automobile using top mount assemblies in accordance with the present disclosure;

FIG. 2 is a perspective view of an exemplary top mount in accordance with the present disclosure;

FIG. 3 is an exploded perspective view of the top mount depicted in FIG. 2;

FIG. 4 is a cross-sectional side view taken along line 4-4 as shown in FIG. 2;

FIG. 5 is a fragmentary perspective view of an isolator of the top mount depicted in FIG. 2; and

FIG. 6 is a fragmentary exploded perspective view of an inner core of the isolator shown in FIG. 5.

### DESCRIPTION

The following description is merely exemplary in nature and is not intended to limit the present disclosure, application, or uses. It should be understood that throughout the drawings, corresponding reference numerals indicate like or corresponding parts and features.

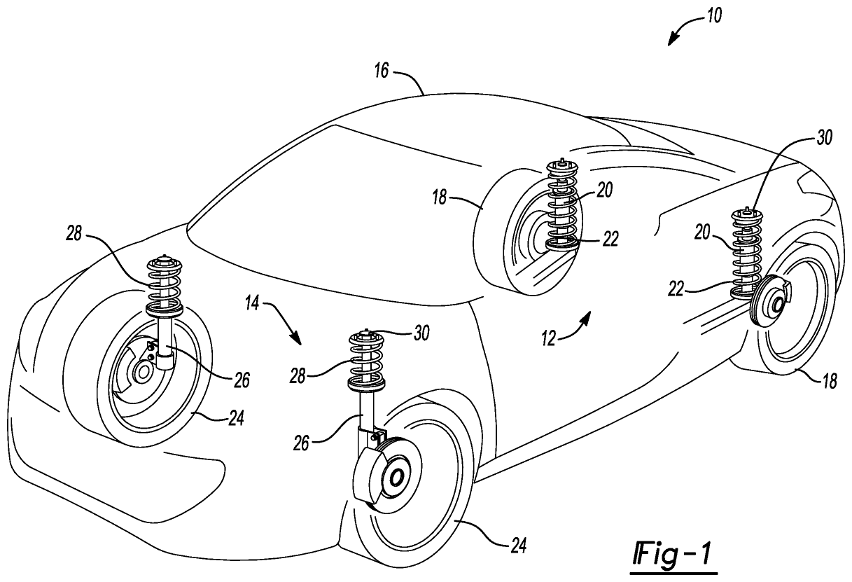

FIG. 1 depicts an exemplary vehicle 10 incorporating a suspension system including top mount assemblies in accordance with the teachings of present disclosure. A top mount assembly may more generally be identified as a suspension mount. Vehicle 10 includes a rear suspension 12, a front suspension 14 and a body 16. Rear suspension 12 is adapted to operatively support the vehicle's rear wheels 18. Rear suspension 12 is operatively connected to body 16 by means of a pair of dampers 20 and a pair of helical coil springs 22. Front suspension 14 operatively supports the vehicle's front wheels 24. Front suspension 14 is operatively connected to body 16 by means of a second pair of dampers 26 and by a pair of helical coil springs 28. Dampers 20 and 26 serve to dampen the relative motion of the unsprung portion (i.e. front and rear suspensions 12 and 14, respectively) and the sprung portion (i.e. body 16) of vehicle 10. The term “damper” as used herein is intended to include at least shocks and struts. The spring and shock arrangements relating to dampers 20 and springs 22 may be separate spaced apart components or coil-over arrangements in an independent rear suspension, as shown.

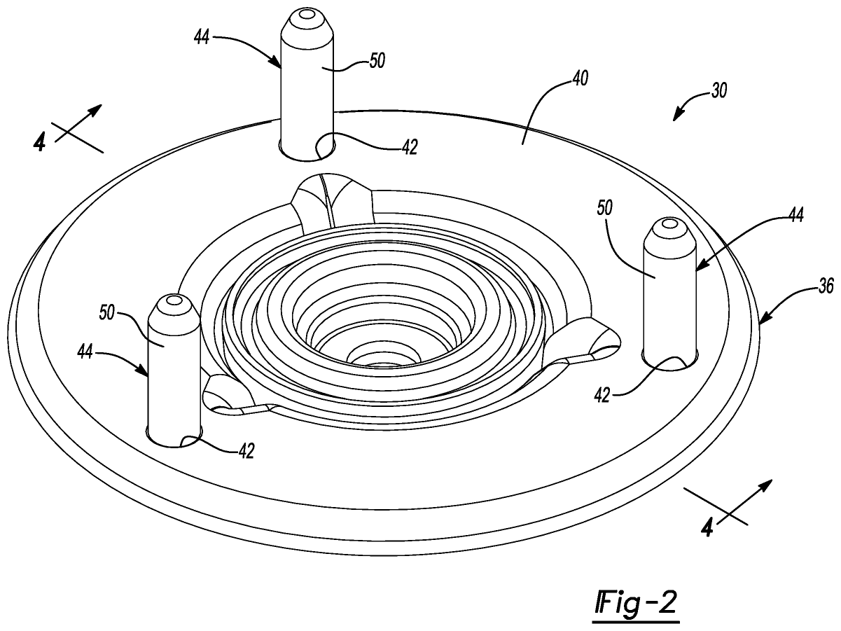

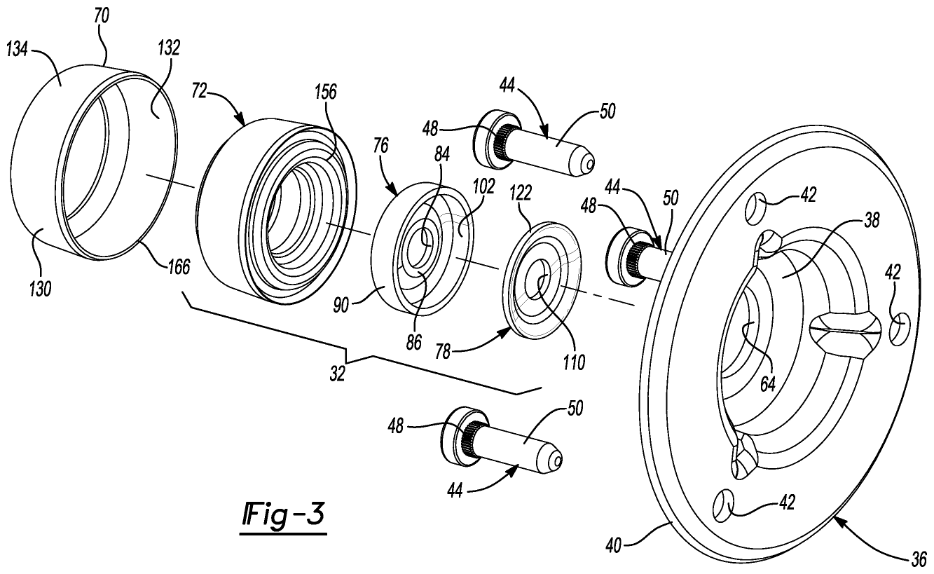

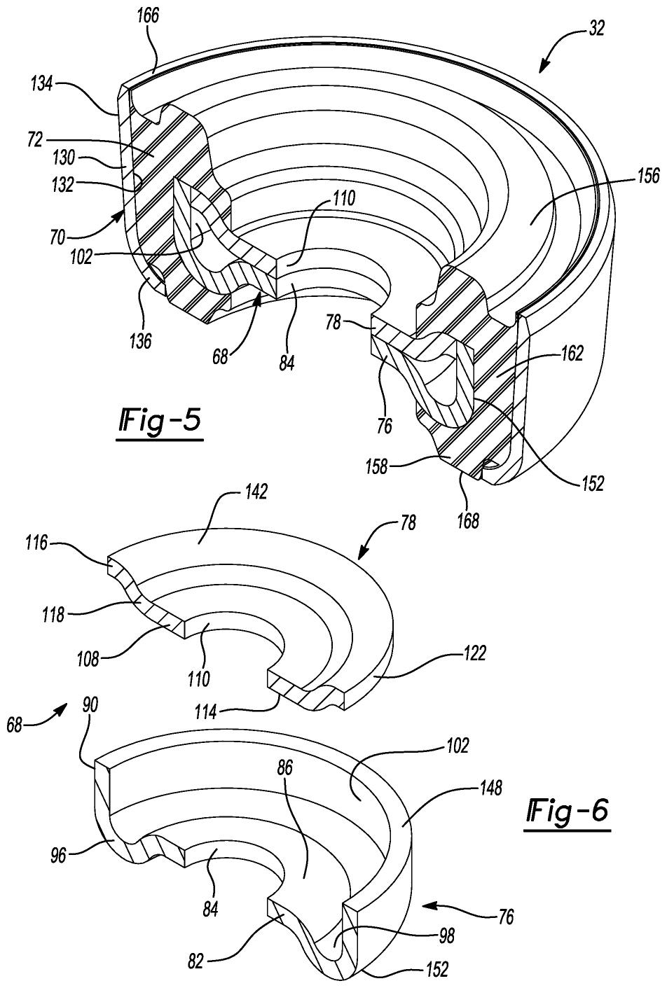

Referring now to FIGS. 2-6, a suspension mount or top mount assembly 30 for a damper is depicted in accordance with an embodiment of the present disclosure. Top mount assembly 30 generally includes an elastomeric isolator 32 disposed within a housing 36. Housing 36 is typically constructed as a steel stamping. Alternatively, housing 36 may be formed from cast aluminum. Housing 36 includes a cup portion 38 integrally formed with a flange portion 40. Flange portion 40 radially outwardly extends from cup portion 38 and includes a plurality of apertures 42 extending therethrough. Fasteners 44 extend through apertures 42 and may be fixed to housing 36 via splines 48. Shanks 50 of fasteners 44 may be threaded for engagement with nuts, not shown, when coupling top mount assembly 30 to vehicle 10.

Cup portion 38 includes an end wall 52 and a circumferentially extending side wall 54 integrally formed together as one piece. Side wall 54 includes an inner surface 56. End wall 52 includes an inner surface 58 and an opposite outer surface 60. An aperture 64 extends through end wall 52 for receipt of a portion of the damper such as a piston rod (not shown).

Elastomeric isolator 32 includes an inner core 68, an outer shell 70, and an elastomeric body 72 positioned therebetween. Inner core 68 is an assembly of a first plate 76 and a second plate 78. Each of first plate 76 and second plate 78 are constructed from low-cost steel stampings that may be readily manufactured in high volume from steel sheets. First plate 76 includes a central portion 82 having a substantially flat disk shape with a central aperture 84 extending therethrough. Central portion 82 includes a substantially planar surface 86. First plate 76 also includes a substantially cylindrically shaped outer wall 90. Both central aperture 84 and outer wall 90 share a common axis of alignment with a longitudinal axis 92 of top mount assembly 30. A circumferentially extending curved wall portion 96 connects central portion 82 with outer wall 90. The shape of curved wall portion 96 defines a recess 98 of first plate 76. Outer wall 90 includes a circumferentially extending inner surface 102.

Second plate 78 includes a substantially disk-shaped central portion 108 including a central aperture 110 extending therethrough. Central portion 108 includes a substantially planar surface 114. Second plate 78 also includes a radially outwardly extending flange portion 116 fixed to central portion 108 by a circumferentially extending curved wall portion 118. Flange portion 116 includes an annular outer surface 122.

Annular outer surface 122 defines an outer diameter slightly greater than an inner diameter defined by circumferentially extending inner surface 102. To assemble inner core 68, first plate 76 and second plate 78 are moved toward one another to engage annular surface 122 with inner circumferentially extending inner surface 102 in a press-fit arrangement. First plate 76 and second plate 78 are moved toward one another until planar surface 86 and planar surface 114 are in contact with one another. Central portion 82 is positioned adjacent to central portion 108 after assembly. Central aperture 84 is coaxially aligned with central aperture 110. In the embodiment depicted in the figures, both first plate 76 and second plate 78 have the same cross-sectional thickness. This configuration is merely exemplary and provides a nonlimiting example. First plate 76 and second plate 78 may be constructed from sheets of similar material or dissimilar materials without departing from the scope of the present disclosure.

Outer shell 70 includes a circumferentially extending wall 130 including an inner surface 132 and an outer surface 134. Outer shell 70 includes a curled end 136 radially inwardly extending from wall 130. Outer wall 90 extends substantially parallel to axis 92. In similar fashion, circumferentially extending wall 130 of outer shell 70 also extends substantially parallel to longitudinal axis 92.

Once inner core 68 has been assembled as previously discussed, both inner core 68 and outer shell 70 are positioned within an injection mold. Molten elastomer is injected within the mold such that elastomeric body 72 bonds to inner surface 102 as well as an inner surface of curved wall portion 96. Elastomeric body 72 is also over-molded on an adhesion surface 142 of second plate 78, an end face 148 of outer wall 90 and an adhesion surface 152 of first plate 76. On the opposite side, elastomeric body 72 is molded to inner surface 132 of outer shell 70.

Elastomeric body 72 includes a first snubber 156, a second snubber 158 and a hollow cylindrically shaped central portion 162 positioned therebetween.

An axial length of outer wall 90 extends a magnitude sufficient to trap central portion 162 of elastomeric body 72 between outer wall 90 and circumferentially extending wall 130. Relative movement between inner core 68 and outer shell 70 is restricted based on the mechanical properties of elastomeric body 72 as will described in further detail. It should be appreciated that the axial length of outer wall 90 is preferably 50-90% the axial extent of circumferentially extending wall 130. This geometric association places a desirable predetermined amount of central portion 162 in shear loading when inner core 68 and outer shell 70 are urged to move axially relative to one another.

First snubber 156 is shaped as annular ring axially extending from central portion 162. At least a portion of first snubber 156 axially extends beyond an end face 166 of outer shell 70. Based on this geometry, first snubber 156 is compressed against a portion of vehicle 10 (not shown) when housing 36 is fixed to vehicle 10.

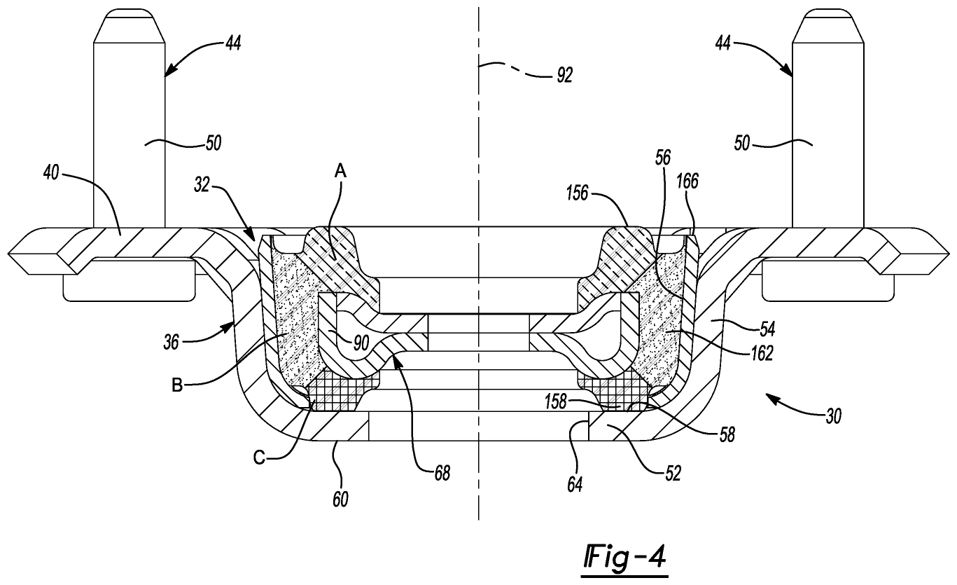

Second snubber 158 is initially molded to include an annular land 168. Prior to positioning elastomeric isolator 32 within housing 36. Annual land 168 axially extends beyond the axial extent of outer shell 70. As best shown in FIG. 4, second snubber 158 is placed in compression as annular surface 168 engages inner surface 58 of end wall 52. Outer shell 70 is positioned in a press fit assembly condition with housing 36 in such a manner to place second snubber 158 in compression. Similarly, first snubber 156 is placed in compression when top mount assembly 30 is fixed to the vehicle.

Once installed on the vehicle, elastomeric body 72 includes three zones of loading as shown in FIG. 4. First snubber 156 is associated with a first loading zone A that is placed in compression once top mount assembly 30 is fixed to vehicle 10. First loading zone A is also placed in compression when axial loading occurs generally along longitudinal axis 92. Central portion 162 also includes a generally trapezoid shaped cross-section identified as zone B. A majority of the material within zone B is positioned between outer wall 90 of inner core 68 and wall 130 of outer shell 70. Based on elastomeric body 72 being bonded to inner surface 132 and adhesion surface 152, central portion 162 of elastomeric body 70 is placed in shear when inner core 68 is loaded relative to housing 36 in the longitudinal direction along longitudinal axis 92. Second snubber 158 is associated with the third loading zone C. Zone C is substantially trapezoidally-shaped and placed in compression when elastomeric isolator 32 is pressed into housing 36. Zone C may also be loaded in compression during vehicle operation when axial loads are applied attempting to move inner core 68 relative to outer shell 70 and housing 36. During transverse or radial loading relative to longitudinal axis 92, the load conditions in the three zones previously described are reversed. Namely, a radial load places zone A and zone C in shear while zone B is placed in compression.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. A damper mount, comprising:
a housing; and
an isolator coupled to the housing, the isolator comprising:
an inner core including a first plate coupled to a second plate, the first plate including a circumferentially extending outer wall, the second plate including a flange positioned in engagement with the outer wall,
an outer shell including a circumferentially extending wall, the inner core being circumscribed by the wall of the outer shell, and
an elastomeric body bonded to the outer shell as well as the first plate and the second plate of the inner core, wherein the circumferentially extending outer wall of the first plate and the circumferentially extending wall of the outer shell extend substantially parallel to one another with a portion of the elastomeric body positioned therebetween.

2. The damper mount of claim 1, wherein the first plate includes a central portion and the second plate includes a central portion positioned adjacent to and in contact with the central portion of the first plate.

3. The damper mount of claim 1, wherein the first plate is coupled to the second plate in a press fit.

4. The damper mount of claim 1, wherein the outer shell includes a curled end and the inner core includes a curved surface, wherein a portion of the elastomeric body is trapped between the curled end and the curved surface to restrict relative axial movement between the inner core and the outer shell.

5. The damper mount of claim 1, wherein the elastomeric body includes a first snubber axially extending beyond a first end of the outer sleeve and a diametrically opposed second snubber axially extending beyond a second opposite end of the outer shell when in an unloaded condition.

6. The damper mount of claim 5, wherein the second snubber is compressed between the inner core and the housing when the isolator is assembled to the housing.

7. The damper mount of claim 1, wherein the inner core includes a central aperture extending therethrough.

8. The damper mount of claim 1, wherein the elastomeric body includes a first zone loaded in compression, a second zone loaded in shear and a third zone loaded in compression when viewed in cross-section.

9. The damper mount of claim 1, wherein the first plate and the second plate include shaped flat steel sheets.

10. The damper mount of claim 1, wherein the housing includes a cup portion and a radially outwardly extending flange portion, the cup portion being in receipt of the outer shell.

11. The damper mount of claim 10, wherein the outer shell is press fit to the housing.

12. The damper mount of claim 10, wherein the flange portion includes an aperture in receipt of a fastener extending therethrough.

13. The damper mount of claim 1, wherein the circumferentially extending outer wall of the first plate includes an axial length 50-90% of an axial length of the circumferentially extending wall of the outer shell.

14. A damper mount, comprising:
a housing; and
an isolator coupled to the housing, the isolator comprising:
an inner core including a first plate coupled to a second plate, the first plate including a circumferentially extending outer wall, the second plate including a flange including an annular outer surface, the annular outer surface being positioned in engagement with an inner surface of the outer wall,
an outer shell including a circumferentially extending wall circumscribing the inner core, and
an elastomeric body bonded to the circumferentially extending wall of the outer shell and the first plate, the elastomeric body including a central portion positioned between the circumferentially extending outer wall and the outer shell wall being loaded in shear in response to a load attempting to move the inner core relative to the outer shell in an axial direction.

15. The damper mount of claim 14, wherein the elastomeric body includes a first snubber axially extending beyond a first end of the outer sleeve and a diametrically opposed second snubber axially extending beyond a second opposite end of the outer shell when in an unloaded condition.

16. The damper mount of claim 15, wherein the second snubber is compressed between the inner core and the housing when the isolator is assembled to the housing.

17. The damper mount of claim 14, wherein the first plate includes a central portion and the second plate includes a central portion positioned adjacent to and in contact with the central portion of the first plate.

18. The damper mount of claim 14, wherein the outer shell includes a curled end and the inner core includes a curved surface, wherein a portion of the elastomeric body is trapped between the curled end and the curved surface to restrict relative axial movement between the inner core and the outer shell.

19. The damper mount of claim 14, wherein the housing includes a cup portion and a radially outwardly extending flange portion, the cup portion being in receipt of the outer shell.

20. The damper mount of claim 19, wherein the outer shell is press fit to the housing.
